(19) United States
(12) Patent Application Publication
(10) Pub. No.: US 2006/0219751 A1
(43) Pub. Date: Oct. 5, 2006

(54) Magazine for pneumatic nailers

(76) Inventors: Yao-Te Yang, Ta Li City (TW); Hung-Ming Huang, Ta Li City (TW)

Correspondence Address: PHILLIP LIU, 6980, WHITEOAK DR., RICHMOND, BC, V7EAZ9, CA

(21) Appl. No.: 11/091,472

(22) Filed: Mar. 29, 2005

(51) Int. Cl. B25C 5/06

(52) U.S. Cl. 227/120; 227/113

(57) ABSTRACT

A pneumatic nailer includes a magazine connected to the nose portion and includes two sidewalls between which a receiving space is defined so as to receive nails therein. A cover is slidably connected between the two sidewalls and a spring is connected to the cover so as to push a push plate movably located at an inside of the cover. A magnet is connected to the cover and magnetically attracts the push plate such that when the cover is pushed to close the magazine, the push plate is not move instantly with the cover. By this way, after the cover is moved to cover a part of the nails, the push plate starts to move to push the nails so as to prevent deformation of the wires connecting the nails.

### FIELD OF THE INVENTION

The present invention relates to a magazine for a pneumatic nailer and the push plate in the magazine is attracted by a magnet which delays the movement while the cover of the magazine is pushed to close the magazine.

### BACKGROUND OF THE INVENTION

A conventional pneumatic nailer is disclosed in FIG. 6 and generally includes a barrel 100 and a handle 101 is connected to the barrel 100. A nose portion 102 is connected to a front end of the barrel 100 and a magazine 103 is connected to the nose portion 102 so as to supply nails 104 into the nose portion 102. The magazine 103 includes a cover 105 and a push plate 106 which pushes the nails 104 toward the nose portion 102. After loading the nails 104 in the magazine 103, the user usually pushes the cover 105 toward the nose portion 102 and the push plate 106 is moved together with the cover 105 to be in contact with the nails 104. Nevertheless, when the user pushes the cover 105, the push plate 106 hits the nails 104 and sometimes the impact hitting the nails 104 deforms the wires connecting the nails 104 as shown. Because the cover 105 is not yet moved to its close position when the push plate 106 hits the nails 104, so that the wires connecting the nails 104 deforms outward. The deformation affects the feeding of the nails 104.

The present invention intends to provide a magazine that has a magnet which delays the movement of the push plate till a part of the nails is covered by the cover.

### SUMMARY OF THE INVENTION

The present invention relates to a pneumatic nailer which comprises a barrel having a nose portion connected to a front end thereof and a handle is connected to the barrel. A trigger is connected to the handle. A magazine is connected to the nose portion and includes two sidewalls between which a cover is slidably connected. A spring is connected to the cover and a push plate is movably located at an inside of the cover and biased by the spring. A magnet is connected to the cover and magnetically attracts the push plate.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the magnet and the magazine of a pneumatic nailer, wherein the cover of the magazine is not close the space in the magazine;

FIG. 2 shows that the magnet is engaged with the hole in the cover of the magazine;

FIG. 3 shows nails are loaded in the space of the magazine;

FIG. 4 shows that the front end of the cover moves to position “L1” and the push plate is not yet moved by the attraction of the magnet;

FIG. 5 shows that the front end of the cover moves to position “L2” and the push plate moves to contact the nails, and

FIG. 6 shows that the wires connecting nails are deformed by the impact of the push plate of a conventional pneumatic nailer.

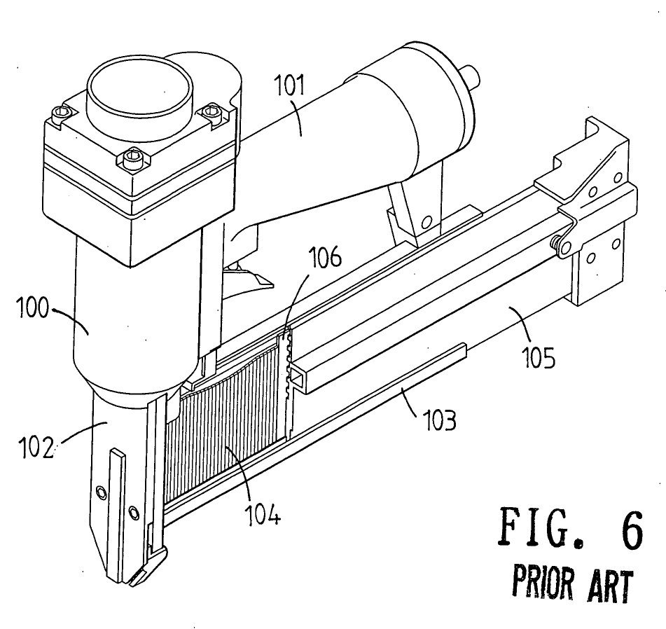

### DETAILED DESCRIPTION OF THE PREFERRED EMBODIMENT

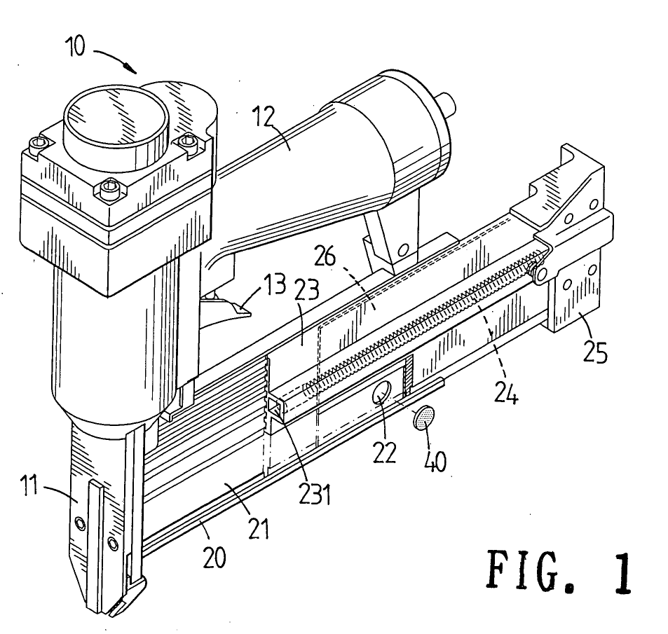

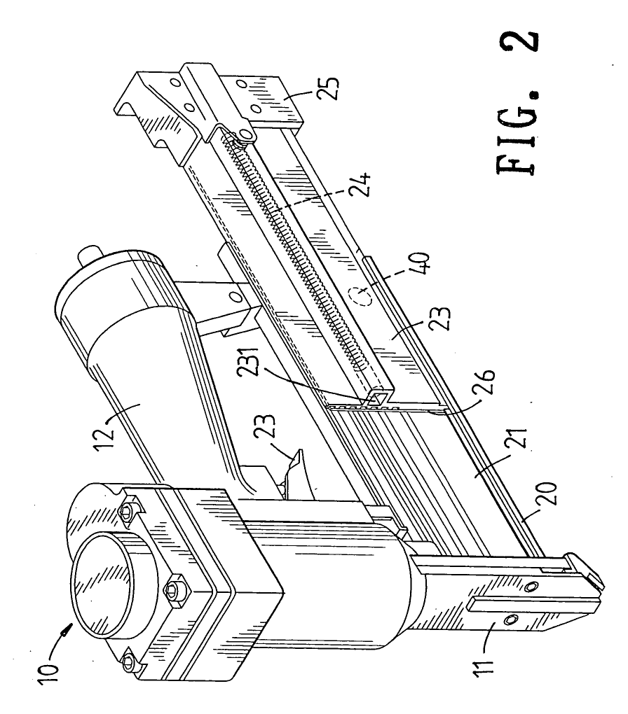

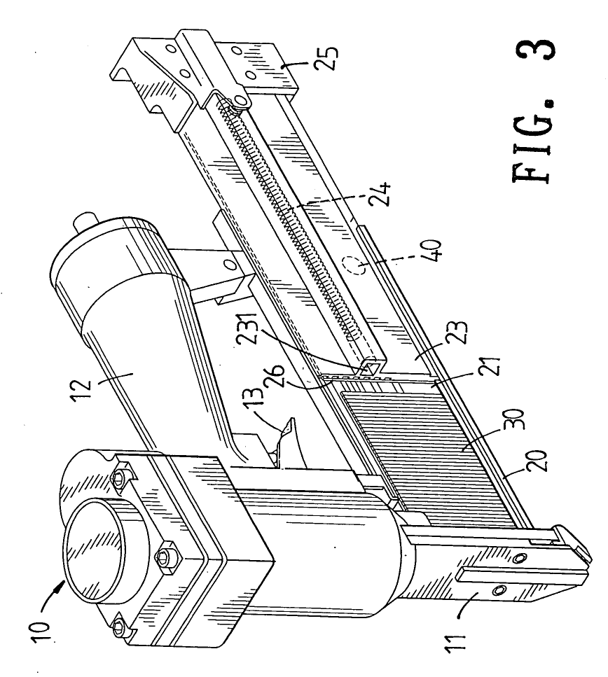

Referring to FIGS. 1 and 2, the pneumatic nailer of the present invention comprises a barrel 10 with a nose portion 11 connected to a front end thereof and a handle 12 is connected to the barrel 10. A trigger 13 is connected to the handle 12 so that when the trigger 13 is pulled, a nail is ejected from the nose portion 11. A magazine 20 has one end connected to the nose portion 11 and the other end of the magazine 20 is connected to an extension portion extending from the handle 12. The magazine 20 includes two sidewalls between which a receiving space 21 is defined. Nails 30 (FIG. 3) connected by wires are loaded in the space 21 and a cover 23 is slidably connected between the two sidewalls to cover the nails 30 when a front end of the cover 23 reaches the nose portion 11. A ridge portion 231 extends from the cover 23 and a spring 24 is received in the ridge portion 231. An end cap 25 is connected to a rear end of the cover 23 and is able to lock the cover 23 relative to the magazine 20. A push plate 26 is movably located at an inside of the cover 23 and biased by the spring 24. The cover 23 includes a hole 22 defined therethrough and a magnet 40 is engaged with the hole 22. The magnet 40 magnetically attracts the push plate 26.

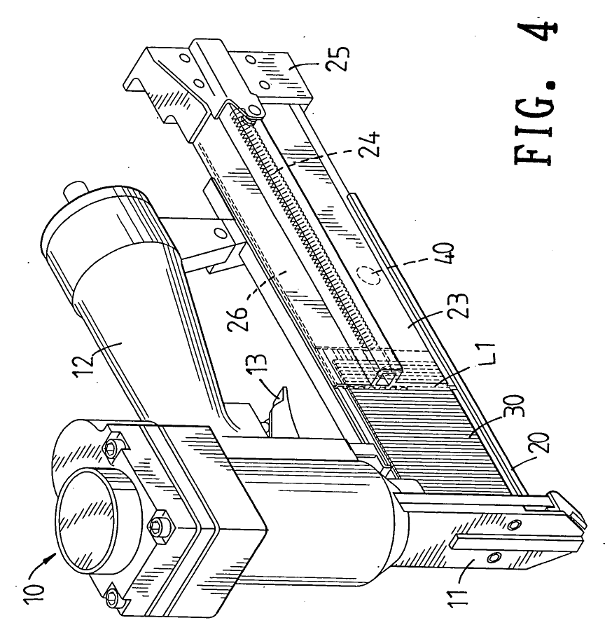

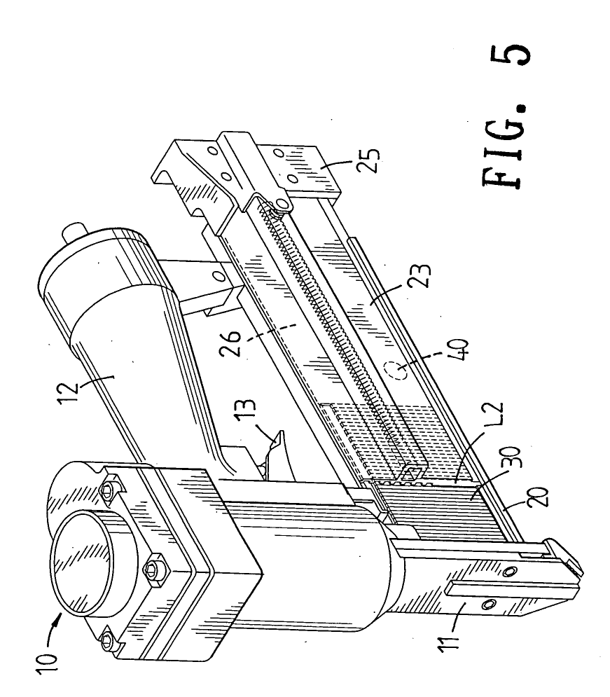

Further referring to FIG. 3, the cover 23 is pulled away from the nose portion1 so as to load the nails 30 in the space 21 in the magazine 202. The use then pushes the end cap 25 toward the nose portion 11 after the nails 30 are loaded, the cover 23 is pushed toward the nose portion 11 and the front end of the cover 23 reaches the position “L1” as shown in FIG. 4, where ⅓ of the nails 30 are covered by the cover 23 while the magnet 40 magnetically attracts the push plate 26 which is not yet moved with the cover 23. As shown in FIG. 5, when the front end of the cover 23 is moved to position “L2” to cover ½ of the nails 30, the spring force of the spring 24 overcomes the magnetic force of the magnet 40 so that the push plate 26 is pushed by the spring 24 to contact the last nail 30. It is noted that because at least ½ of the nails 30 is covered by the cover 23, so that the wires connecting the nails 30 cannot deform and are stopped by the inside of the cover 23.

The magnet 40 is easily connected to the cover 23 without too many extra machining processes done to the existed cover 23 so that the nails 30 are ensured to be well positioned in the space 21 by the cover 23 before the push plate 26 hits the nails 30.

While we have shown and described the embodiment in accordance with the present invention, it should be clear to those skilled in the art that further embodiments may be made without departing from the scope of the present invention.

What is claimed is:

1. A pneumatic nailer comprising:
a barrel having a nose portion connected to a front end thereof and a handle connected to the barrel, a trigger connected to the handle;
a magazine connected to the nose portion and including two sidewalls between which a receiving space is defined, a cover slidably connected between the two sidewalls and a spring connected to the cover, a push plate movably located at an inside of the cover and biased by the spring, and
a magnet connected to the cover and magnetically attracting the push plate.

2. The nailer as claimed in claim 1, wherein the cover includes a hole defined therethrough and the magnet is engaged with the hole.

3. The nailer as claimed in claim 1, wherein the magnet magnetically attracts the push plate and holds the push plate in position when the cover is initially pushed to extend the spring.
